(19) United States
(12) Patent Application Publication
(10) Pub. No.: US 2016/0364540 A1
(43) Pub. Date: Dec. 15, 2016

(54) PATIENT COMMUNICATION SYSTEM

(71) Applicant: Regina Holmes, Harker Heights, TX (US)

(72) Inventor: Regina Holmes, Harker Heights, TX (US)

(21) Appl. No.: 14/921,985

(22) Filed: Oct. 23, 2015

Related U.S. Application Data
(63) Continuation-in-part of application No. 14/735,810, filed on Jun. 10, 2015.

(51) Int. Cl. G06F 19/00; H04L 29/08; G06K 7/10

(52) U.S. Cl. CPC G06F 19/3418; G06K 7/10792; G06K 7/10861; H04L 67/141

(57) ABSTRACT

A patient communication system includes at least one patient communication device including a speaker and a microphone, a device number database having at least one quasi-unique device number, at least one display device associated with at least one user code, a user code database including at least one user code, a barcode scanner and a computer processing component. The patient communication device is associated with at least one quasi-unique device number magnetically represented as a barcode. The quasi-unique device number is associated with a patient database. The computer processing component is configured to associate the user code and the quasi-unique patient communication device number, and invoke a pairing function to send a signal to activate a device communication connection session. The computer processing component is configured to allow display of patient information from the patient database on the display device.

### CROSS-REFERENCE TO RELATED APPLICATIONS

This application claims priority to U.S. patent application Ser. No. 14/735,810, filed on Jun. 10, 2015, which is hereby incorporated by reference in its entirety.

### BACKGROUND OF THE INVENTION

1. Field of Invention

This invention relates to the field of telecommunications and more specifically to a transceiver integrated with other devices for use in a healthcare environment.

2. Description of Prior Art

Effective patient communication is an essential element of quality care and treatment in healthcare settings. In the absence of an adequate verbal exchange of information between the caregiver and patient, it is difficult to obtain an accurate diagnosis, developed a relevant treatment plan, obtain informed consent, educate patients or to generally create an environment that is optimally conducive to quality patient care and holistic well-being.

There are several problems known in the art with respect to interviewing patients in a hospital setting or other health care environment as well. Communication with patients may occur in a non-confidential environment, such as a shared room or office, where other persons are present and can potentially hear a verbal exchange. Other communication problems routinely occur when the patient has a hearing impairment, and does not have hearing devices in place during the interview. Language barriers between the caregiver and patient may also cause further inconveniences and inadequacies when providing quality care.

Additionally, the interview skills of the health care professionals may vary as to their ability to conduct thorough assessments. For example, health care providers may vary in their approach to asking the patient necessary follow-up questions that may aid in the discovery of key symptoms that could in-turn contribute to a lifesaving diagnosis.

There is an unmet need in the art for a communications system that allows private communication between a patient and a healthcare provider in public healthcare settings.

There is a further unmet need to ensure consistency in data gathered from patient interviews.

### BRIEF SUMMARY OF THE INVENTION

A patient communication system includes at least one patient communication device including a speaker and a microphone, a device number database having at least one quasi-unique device number, at least one display device associated with at least one user code, a user code database including at least one user code, a barcode scanner and a computer processing component. The patient communication device is associated with at least one quasi-unique device number magnetically represented as a barcode. The quasi-unique device number is associated with a patient database. The computer processing component is configured to associate the user code and the quasi-unique patient communication device number, and invoke a pairing function to send a signal to activate a device communication connection session. The computer processing component is configured to allow display of patient information from the patient database on the display device.

### BRIEF DESCRIPTION OF SEVERAL VIEWS OF THE DRAWING(S)

FIG. 1a illustrates an exemplary embodiment of a patient communication system.

FIG. 1b illustrates an exemplary embodiment of a user interface for a patient communication system.

FIG. 2 illustrates an exemplary embodiment of a patient communication system method.

### DETAILED DESCRIPTION OF THE INVENTION

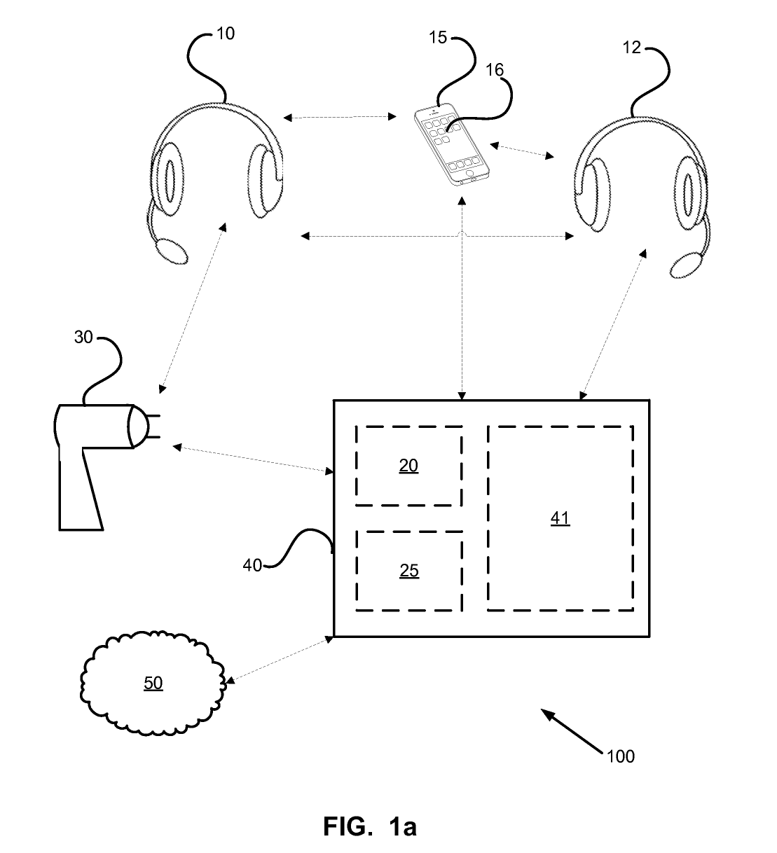

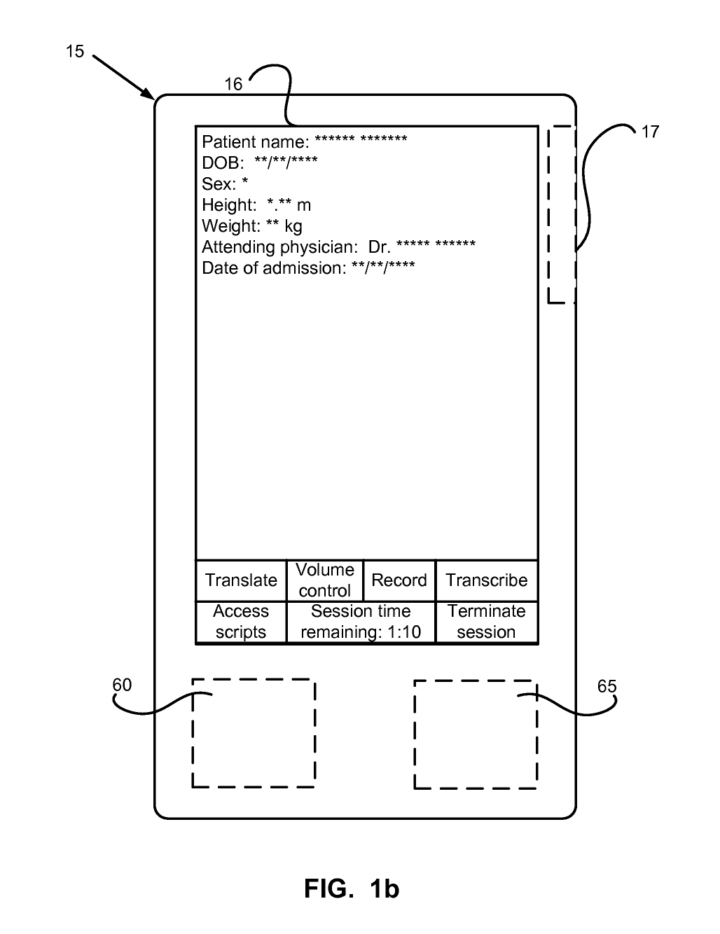

FIG. 1a illustrates an exemplary embodiment of a patient communication system 100. FIG. 1b illustrates an exemplary embodiment of user interface 16 for patient communication system 100. In the exemplary embodiment shown, patient communication system 100 includes patient communication device 10, care provider headset 12, and display device 15. In the exemplary embodiment shown, patient communication device 10 is a wireless headset. In other embodiments, patient communication device 10 is a Bluetooth-enabled earpiece. In various embodiments, patient communication device 10 is associated with a quasi-unique device number represented as a barcode. In various embodiments, the barcode may be located on a patient wristband or other identification, or on an external surface of patient communication device 10. The quasi-unique device number is associated with a patient database 20 which is a database of patient information.

In the embodiment shown, a care provider enters a user code which is associated with a care provider identity maintained in care provider database 25. In various embodiments, patient communication system 100 may include barcode scanner 30.

In various embodiments patient communication device 10 and display device 15 may be are configured with volume control software.

In the embodiment shown in FIG. 1, patient communication system 100 includes a computer processing component 40 which is configured to associate at least one user code and at least one quasi-unique device number, and invoke a pairing function to send a signal to activate a device communication connection session. Computer processing component 40 is also configured to allow display of patient information from the patient database 20 on a user interface 16 of display device 15.

In certain embodiments, computer processing component 40 includes a memory unit 41 configured to be compliant with data storage requirements of the Health Insurance Portability and Accountability Act (HIPAA). In still other embodiments, computer processing component 40 is configured to invoke a tracking function to track user information for display device 15.

In the embodiment shown, all patient information displayed on display device 15 is transitory and deleted when the device is turned off so that no confidential patient data is transmitted. In other embodiments user interface 16 may be configured to allow a user to directly annotate patient database 25.

In still other embodiments, display device 15 may include a wired or wireless connection to a communications network 50. This connection is limited to approved communications networks. In various embodiments, this network connectivity may allow a user to invoke translation functionality on translation software stored remotely. Alternatively, display device 15 may be internally configured with translation software which displays linguistic prompts on user interface 16 for a health care provider.

In various embodiments, display device 15 may further be configured to receive input and select data from a general interview script database 60. General interview script database 60 includes a plurality of general interview scripts and/or a plurality of general questionnaires. These general interview scripts and/or general questionnaires do not require health information protected by HIPAA.

Alternatively, a patient-specific interview script database 65 may be stored on display device 15. Patient-specific interview script database 65 includes a plurality of patient-specific interview scripts and/or a plurality of patient-specific questionnaires.

In various embodiments, display device 15 may include at least one authentication feature selected from the group consisting of: a fingerprint reader 17, manual input of at least one user name and at least one password, or scanning a barcode that corresponding to a care provider's user code. In other embodiments, display device 15 may be configured to terminate activation or display functions if a user exceeds a maximum time parameter or a maximum distance parameter. In still other embodiments, display device 15 may be configured to terminate an activation or display function if a user invokes a termination function. In some embodiments, display device 15 is configured with recording or transcription software.

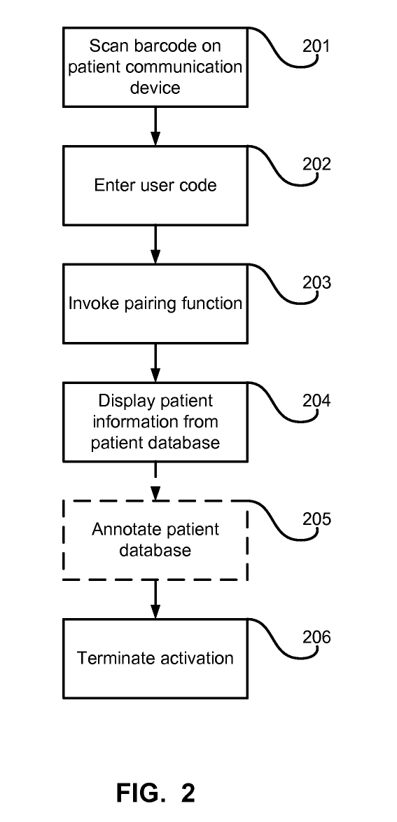

FIG. 2 illustrates an exemplary embodiment of a patient communication system method 200.

It will be understood that many additional changes in the details, materials, procedures and arrangement of parts, which have been herein described and illustrated to explain the nature of the invention, may be made by those skilled in the art within the principle and scope of the invention as expressed in the appended claims. It should be further understood that the drawings are not necessarily to scale; instead, emphasis has been placed upon illustrating the principles of the invention.

What is claimed is:

1. A patient communication system comprising:
at least one patient communication device comprising a speaker and a microphone, wherein said at least one patient communication device is associated with at least one quasi-unique device number magnetically represented as a barcode, wherein said at least one quasi-unique device number is associated with a patient database;
a device number database comprising at least one quasi-unique device number;
at least one display device associated with at least one user code;
a user code database comprising at least one user code;
a barcode scanner; and
a computer processing component,
wherein said computer processing component is configured to associate said at least one user code and said at least one quasi-unique device number and invoke a pairing function to send a signal to activate a device communication connection session,
wherein said computer processing component is configured to display patient information from said patient database on said at least one display device.

2. The system of claim 1 wherein patient information displayed on said at least one display device is transitory.

3. The system of claim 1 wherein said at least one display device further comprises a user interface capable of being activated by a user.

4. The system of claim 3 wherein said user interface is configured to allow a user to directly annotate said patient database.

5. The system of claim 1 wherein said at least one display device further comprises a wired or wireless connection to a communications network, wherein said connection is limited to approved communications networks.

6. The system of claim 1 wherein said at least one display device is configured to display a status of said headset communication connection session.

7. The system of claim 6 wherein said at least one display device is configured to display additional information on said headset communication connection session.

8. The system of claim 1 wherein said at least one display device further comprises a translation function invoking translation software stored on said at least one display device.

9. The system of claim 1 wherein said at least one display device further comprises a translation function invoking translation software stored remotely from said at least one display device.

10. The system of claim 1 wherein said at least one display device further comprises a general interview script database stored on said at least one display device, wherein said general interview script database comprises a plurality of general interview scripts and/or a plurality of general questionnaires, wherein said plurality of general interview scripts and/or said plurality of general questionnaires do not require health information protected by the Health Insurance Portability and Accountability Act (HIPAA).

11. The system of claim 1 wherein said computer processing component further comprises a memory unit configured to be compliant with HIPAA data storage requirements.

12. The system of claim 11 wherein said computer processing component further comprises a patient-specific interview script database stored on said at least one display device, wherein said patient-specific interview script database comprises a plurality of patient-specific interview scripts and/or a plurality of patient-specific questionnaires.

13. The system of claim 1 wherein said at least one display device further comprises at least one authentication feature selected from the group consisting of: a fingerprint reader, manual input of at least one user name and at least one password, or scanning a barcode that corresponding to a care provider's user code.

14. The system of claim 1 wherein said computer processing component is configured to invoke a tracking function to track user information for said at least one display device.

15. The system of claim 1 wherein said at least one display device is configured to terminate said activation function or said display function if a user exceeds a maximum time parameter or a maximum distance parameter.

16. The system of claim 1 wherein said at least one display device is configured to terminate said activation function or said display function if a user invokes a termination function.

17. The system of claim 1 wherein said computer processing component is configured to transmit prompts to said at least one patient communication device.

18. The system of claim 1 wherein said computer processing component is configured to monitor and track said at least one patient communication device and said at least one display device.

19. The system of claim 1 wherein said at least one patient communication device and said at least one display device are configured with volume control software.

20. The system of claim 1 wherein said at least one display device is configured with recording or transcription software.
